(19) United States
(12) Patent Application Publication
(10) Pub. No.: US 2013/0117704 A1
(43) Pub. Date: May 9, 2013

(54) Browser-Accessible 3D Immersive Virtual Events

(71) Applicants: Darius Lahoutifard, Irvine, CA (US); Guillaume Lurenbaum, Savigny Sur Orge (FR)

(72) Inventors: Darius Lahoutifard, Irvine, CA (US); Guillaume Lurenbaum, Savigny Sur Orge (FR)

(21) Appl. No.: 13/671,232

(22) Filed: Nov. 7, 2012

Related U.S. Application Data
(60) Provisional application No. 61/557,769, filed on Nov. 9, 2011.

(51) Int. Cl. G06F 3/0481; G06T 15/00

(52) U.S. Cl. CPC G06F 3/04815; G06T 15/00
USPC 715/780; 345/419

(57) ABSTRACT

A system adapted to provide multiple immersive three-dimensional (3D) event spaces to multiple sets of users, each set of users associated with a particular 3D event space, includes: a set of web servers adapted to provide multiple URLs, each URL associated with a particular 3D event space; a set of storages communicatively coupled to the set of web servers; and multiple sets of user devices communicatively coupled to the set of web servers across one or more networks, each set of user devices associated with a particular 3D event space. An automated method adapted to set up and host a virtual event includes: receiving a set of event parameters from an event planner; generating a 3D immersive event space based at least partly on the parameters; and providing the 3D event space to multiple participants able to access a URL associated with the event space using a web browser.

### CROSS-REFERENCE TO RELATED APPLICATIONS

This application claims priority to U.S. Provisional Patent Application Ser. No. 61/557,769, filed on Nov. 9, 2011.

### BACKGROUND

There has long been a need for people to come together for meetings, conventions, lectures, classes, etc. Many people want to participate in such meetings without incurring travel costs, finding, reserving, and paying for appropriate meeting locations, etc.

Existing meeting systems are limited and do not provide an immersive interactive virtual event. Online solutions may not allow interaction among participants (or may allow limited interaction such as shared chat, text messaging, etc.) or the event environment, if any. In addition, some systems may require users (e.g., participants such as meeting organizers and/or moderators, attendees, presenters, etc.) to download and/or install proprietary software to a user device associated with the user. Furthermore, existing systems may not allow large conferences and tradeshows to be set up instantly, such that event planners may create and setup the event on their own, without delay and without the involvement of any vendor support personnel, and without having any specific three-dimensional (3D) design skills.

Thus there is a need for an online meeting solution that provides an immersive three-dimensional space allowing interaction among participants (and/or their environment) and that is able to be executed by a web browser and which may be set up instantly in a self-service mode.

### BRIEF SUMMARY

Some embodiments may provide an online system for defining and hosting three-dimensional (3D) immersive virtual events. Such events may be set up by one or more moderators, and may be instantly accessible by attendees using a browser, without requiring download or installation of any proprietary software.

Some embodiments may provide a 3D immersive space where a participant may be able to enter the space using an avatar, move freely within the space, and/or interact with other participants (through their avatars) and/or any other objects in the space. Some such spaces may include various facilities (e.g., virtual display screens, podiums, etc.).

One exemplary embodiment provides a system adapted to provide multiple immersive three-dimensional (3D) event spaces to multiple sets of users, each set of users associated with a particular 3D event space. The system includes: a set of web servers adapted to provide multiple uniform resource locators (URLs), each URL associated with a particular 3D event space; a set of storages communicatively coupled to the set of web servers; and multiple sets of user devices communicatively coupled to the set of web servers across one or more networks, each set of user devices associated with a particular 3D event space.

Another exemplary embodiment provides an automated method adapted to set up and host a virtual event. The method includes: receiving a set of event parameters from an event planner; generating a three-dimensional (3D) immersive event space based at least partly on the set of event parameters; and providing the 3D event space to multiple participants, where each participant is able to access a uniform resource locator (URL) associated with the event space using a web browser.

Yet another exemplary embodiment provides a graphical user interface (GUI) that includes a set of features that allow self-service, instant setup of a three-dimensional (3D) immersive event space. The GUI includes: a set of selectable elements, each selectable element associated with a type of event; a first set of data entry fields, each data entry field in the first set of data entry fields being associated with one or more parameters that define features of the 3D immersive event space; and a second set of data entry fields, each data entry field in the second set of data entry fields either representing visual elements which need to be visible in the virtual event, such as logos or posters, or more generally, being associated with one or more parameters that define features of an event associated with the 3D immersive event space, as well as defining other parameters such as selecting the template of the virtual 3D space to be used as the virtual venue of the event and to be customized for the specific event.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGs.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a conceptual three-dimensional online event system according to some embodiments of the invention;

FIG. 2 illustrates a schematic block diagram of a conceptual network architecture used by some embodiments of the invention;

FIG. 3 illustrates a schematic block diagram of a system including a client-side application and server-side application provided by some embodiments of the invention;

FIG. 4 illustrates a flow chart of a conceptual process used by some embodiments of the invention to set up a 3D online event;

FIG. 5 illustrates a flow chart of a conceptual process used by some embodiments of the invention to allow a user to participate in a 3D event of some embodiments;

FIG. 6 illustrates a flow chart of a conceptual process used by some embodiments of the invention to allow user interaction during a 3D online event;

FIG. 7 illustrates a flow chart of a conceptual process used by some embodiments of the invention to provide a server-side application for a user participating in an event;

FIG. 8 illustrates a flow chart of a conceptual process used by some embodiments of the invention to create an avatar and/or user account;

FIG. 9 illustrates an example graphical user interface (GUI) provided by some embodiments of the invention;

FIG. 10 illustrates another example GUI provided by some embodiments of the invention;

FIG. 11 illustrates another example GUI provided by some embodiments of the invention;

FIG. 12 illustrates another example GUI provided by some embodiments of the invention;

FIG. 13 conceptually illustrates a process of some embodiments for defining and storing an application of some embodiments; and

FIG. 14 illustrates a schematic block diagram of a conceptual computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Broadly, an embodiment of the present invention generally provides a way to define and host a three-dimensional (3D) immersive virtual event that may be instantly set up and may be accessible by multiple attendees, each using a browser, without requiring download or installation of any proprietary software. Such an immersive event may include multiple participants, including lecturer(s) (and/or presenters), attendee(s) (and/or other types of guests), various configuration parameters (e.g., features of the virtual space, attributes associated with the users, etc.), and/or other appropriate elements.

Some embodiments may allow a set of attendees (or users) to interact with various components of the system. The system may include a 3D immersive space where an attendee may be able to enter using an avatar and move freely within the space and may interact with other attendees (through an avatar associated with the attendee) and/or any other objects in the space.

In addition to using the system for virtual events, the system may be adapted for smaller meetings, 3D websites, virtual classrooms, virtual worlds, games, learning environments, and/or other wizard-type processes for building 3D spaces, such as virtual online parties. The system may be used for other entertainment applications such as online concerts, games, shows, virtual theaters, etc.

Several more detailed embodiments of the invention are described in the sections below. Section I provides a conceptual description of a system architecture used by some embodiments. Section II then describes various methods of operation used by some embodiments. Next, Section III describes various example Graphical User Interfaces (GUIs) that may be provided by some embodiments. Section IV then describes a process used to define an application of some embodiments. Lastly, Section V describes a computer system which may implement some of the embodiments of the invention.

### I. System Architecture

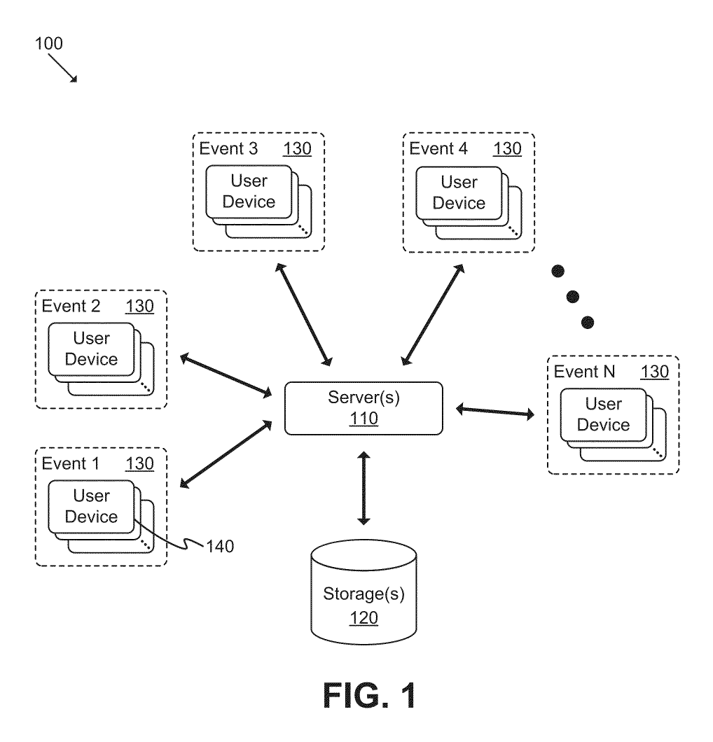

FIG. 1 illustrates a schematic block diagram of a conceptual three-dimensional online event system 100 according to some embodiments of the invention. Specifically, this figure shows various communication pathways among the elements of the system 100. As shown, the system may include one or more servers 110, one or more storages 120, and one or more events 130, each associated with a set of user (or “client”) devices 140.

The server(s) 110 may include one or more electronic devices that are able to execute instructions and/or process data. The server(s) may be able to pass data and/or instructions among one or more storages 120. The storage(s) may be able to store data and/or instructions. The server(s) and/or the storage(s) may be distributed among several locations.

Each conference 130 represents a conceptual grouping of users participating in a particular virtual event. Each user may be associated with one or more user devices (e.g., a user may participate in an event using a phone for voice elements and a personal computer (PC) for multimedia elements, a user may participate using a mobile device, etc.).

The user device(s) 140 may include various types of devices that are capable of communicating with the server(s) 110 (e.g., using one or more networks, or networks of networks). Each user device 140 may include one or more processors, memories, user interface elements, and/or other appropriate elements. Such a user device may be, for instance, a mobile phone, a tablet, a portable computer, desktop computer, etc. Each user device may include one or more display elements (e.g., a screen, indication lights, etc.) and various input elements (e.g., a keypad, touchscreen, etc.).

During operation, the server(s) 110 may send and/or receive data among the storage(s) 120 and the user device(s) 140 associated with each conference 130. The server(s) 110 may process the received data and determine various operations that may be implemented at one or more conference(s) 130. For instance, data may be sent from one or more user device(s) 140 (e.g., a smartphone, a PC, a tablet device, etc.) to the server(s) 110 to set up an online conference, and/or initiate changes to an already existing conference. Such changes and set up may be associated with a particular conference. The users associated with the particular conference may then receive updated data at each user device. Each user device may be capable of running a web browser.

In some embodiments, system 100 may be implemented using only hypertext markup language, fifth revision (HTML5) code. In some other embodiments, the browser may include an applet or plug-in that implements some elements of the system. Some embodiments may allow mobile devices to access HTML5-based code using an appropriate browser that is able to interpret such code, obviating the need to run an applet on the mobile device. Some of these embodiments may allow other devices (e.g., PCs, desktop computing devices, etc.) to load and use an applet running in a browser. The criteria for whether a device uses an applet or an HTML5-capable browser may be made based on various relevant factors (e.g., processing power of the device, whether the device is powered by a battery or AC source, etc.).

The system may utilize and/or provide, for example, computer software, mobile software, online services, phone services, pictures, screen captures, animations, videos, movies, audio recordings, reports, statistics, and/or databases. The system may utilize and/or provide devices which embed such software (e.g., smart phones, tablets, computers, cell phones and/or any other electronic device capable of executing the above mentioned software).

The system may use open source code that is readily available to user devices. The system may use software that runs in a standard browser on standard operating systems. The system may offer an integrated voice/IP functionality such that attendees are able to talk and hear others (e.g., speakers and/or other attendees) inside the same virtual 3D space.

One of ordinary skill in the art will recognize that the system 100 is conceptual in nature and may be implemented in various different ways without departing from the spirit of the invention. For instance, various elements may be removed and/or various other elements may be included. In addition, various other communication pathways may be utilized and/or included.

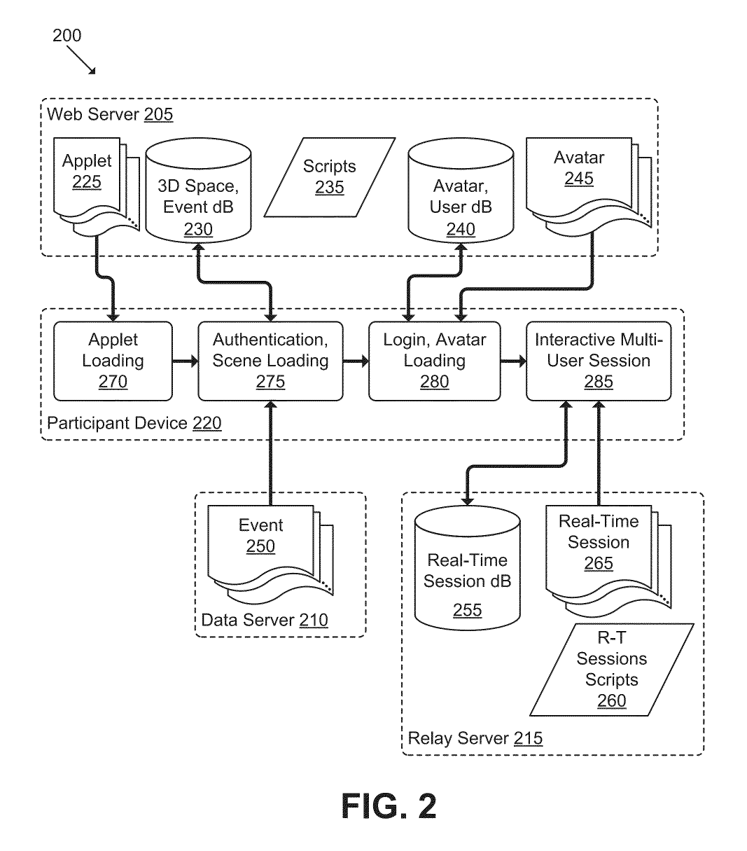

FIG. 2 illustrates a schematic block diagram of a conceptual network architecture 200 used by some embodiments of the invention. Specifically, this figure shows the various communication pathways that may be used at each stage of a user interaction with a 3D event. As shown, the architecture includes a web server 205, a data server 210, a relay server 215, and a participant device 220.

The web server 205, data server 210, and relay server 215 may each include one or more computing devices that are able to connect to one or more networks. The participant device 220 may be any device capable of communicating with the servers 205-215 over one or more networks.

As shown, the web server 205 may include various elements such as a set of applet files 225, a 3D space and event database 230, a set of scripts 235, an avatar and user database 240 and a set of avatar files 245.

Each applet file 225 may include sets of instructions and/or data for executing various client-side application elements. Such applets may include compiled code. The 3D space and project database 230 may include various data elements associated with 3D spaces and/or projects. Each script 235 may include sets of instructions that are able to be executed by, for instance, a web browser. The avatar and user database 240 may include various elements associated with users of the system and any avatar(s) associated with each user. Each avatar file 245 may include various data elements related to an avatar of a user.

As shown, the data server 210 may include a set of event files 250. Each event file may include various relevant parameters, settings, preferences, and/or other elements. Such elements may, for instance, include or be associated with elements of a virtual space (e.g., length, height, and width of a meeting room, etc.), list(s) of associated users (e.g., invited attendees, confirmed attendees, etc.), and/or other appropriate elements.

The relay server 215 may include a real-time session database 255, a set of scripts 260, and one or more real-time session files 265. The real-time session database 255 may include various data elements related to a real-time 3D event session. Each script 260 may include various instructions that provide various features of the real-time 3D environment to a set of users. Each real-time session file 265 may include various relevant data elements, such as, for instance, identifying information for each attendee-user, event data (e.g., multimedia presentations, interaction parameters, etc.), and/or other data elements.

As shown, the participant device 220 may proceed through a series of states when participating in an event. Such states are conceptual in nature, and different embodiments may proceed through different series of states in different orders, include other different states, and/or remove one or more states. In this example, the states include an applet loading stage 270, an authentication and scene loading stage 275, a login and avatar loading stage 280, and an interactive multi-user session stage 285.

During operation, the participant device 220 may navigate to a particular web location, and/or otherwise appropriately initiate participation in a 3D event. The participant device may receive an applet 225 from the web server 205. The participant device 220 may perform applet loading 270. Alternatively, when using HTML5, loading an applet may not be required as such functionality may be provided directly in the HTML5 code. Once the applet has been loaded, the participant device 220 may perform authentication and scene loading 275. Such authentication and scene loading may include communicating with the 3D space and project database 230 and receiving one or more event files 250 from the data server 210. Next, the participant device 220 may communicate with the web server 205 to perform login and avatar loading 280. Such loading may include receiving one or more avatar files 245 from the web server 205.

The participant device may then provide the interactive multi-user session 285. Providing such a session may include communicating with the real-time session database 255 and receiving one or more real-time session files 265 from the relay server 215. During operation, the participant device 220 may execute various scripts 235 and 260 provided by the web server 205 and relay server 215, respectively.

One of ordinary skill in the art will recognize that the architecture 200 described above may be implemented in various different ways without departing from the spirit of the invention. For instance, the various servers 205-215 may be provided by a single device. In addition, various elements may be removed and/or various other elements may be included. Furthermore, various other communication pathways may be utilized and/or included.

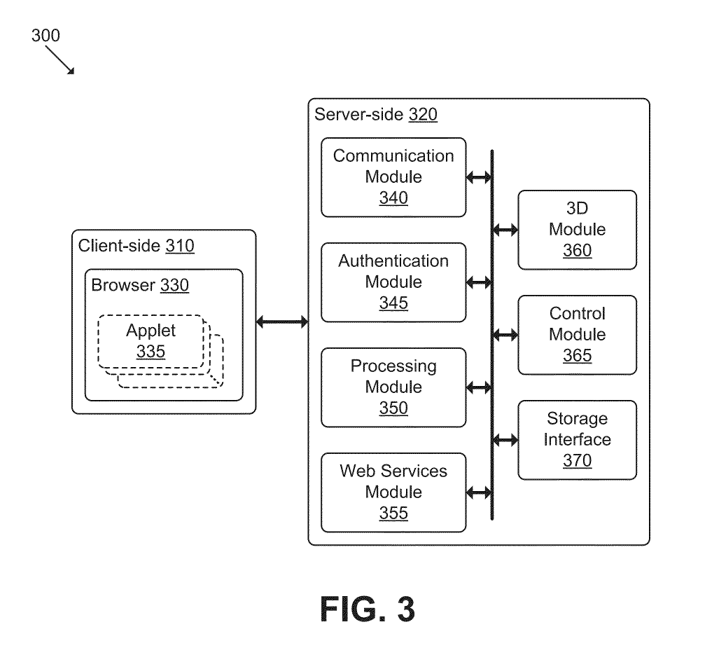

FIG. 3 illustrates a schematic block diagram of a system 300 including a client-side application 310 and server-side application 320 provided by some embodiments. Specifically, this figure shows various system components that may be provided by a client (or client-side) application, and a server (or server-side) application. Such applications 310-320 may be executed by one or more appropriate devices.

The client-side application 310 may include a browser 330 which may execute one or more applets 335. Each applet may define a set of compiled instructions to be executed by the browser 330, as appropriate. Alternatively, HTML5 may allow the system to operate using only the browser 330 without needing any applets or other compiled code.

The browser 330 may be adapted to communicate with the communication module 340 using an appropriate protocol (e.g., hypertext transfer protocol (HTTP)). Such communication may utilize one or more networks or sets of networks (e.g., cellular networks, the Internet, etc.). Each applet 335 may be adapted to provide various features associated with a 3D event.

The server-side application 320 may include a communication module 340, an authentication module 345, a processing module 350, a web services module 355, a 3D module 360, a control module 365, and/or a storage interface 370.

The communication module 340 may be adapted to communicate with various user devices, via the browser 330. The authentication module 345 may be adapted to confirm and/or validate user account information (e.g., a login name and password) supplied by a user (e.g., an attendee, a moderator, etc.).

The processing module 350 may be adapted to execute instructions and/or process data used by the server-side application 320. In addition, the processing module 350 may be adapted to manage communication among the various other modules. The web services module 355 may be adapted to interact with and/or utilize various services available over various networks (e.g., social networking services, messaging services, etc.).

The 3D module 360 may be adapted to provide 3D images, video, and/or other content for one or more 3D events. The 3D module may include a 3D modeling engine that may be used for creating and customizing a 3D space with various 3D scenery, settings, accessories, etc. The 3D module may include a real-time 3D rendering engine which may be used for realistic visualization of the 3D spaces. The 3D module may include streaming technology through relay servers which may enable synchronized visualization of various events occurring in the 3D space (e.g., slides presented by a presenter, a video broadcast, a chat session, and/or other avatar actions and/or movements).

The 3D module may allow users to control and/or move their personal avatars in a 3D online event. The 3D module may include a physics engine for detecting collisions between avatars and objects in the 3D space, and may enable avatars to perform movements, prevent them from walking through other 3D objects, etc. The 3D module may include a graphical studio for modifying the virtual space. The 3D module may include an avatar configuration module that may enable attendees to create and/or customize their avatars. In addition, the 3D module may include “player” software that runs inside the browser and allows attendees to interact in various ways.

The control module 365 may be adapted to control and manage the 3D online events used by some embodiments of the invention. The control module may be used, for instance, by an event creator to create an account, from where the event creator may define a set of event parameters (e.g., virtual setting characteristics, event characteristics, event time/date, etc.). The control module may assist in retrieving links to a virtual space for attendees, managing attendee registrations, managing events, and/or managing conference rooms, booths, and/or tradeshow halls. The storage interface 370 may be adapted to interface with various storages that may be available to the server-side application 320.

During operation, a user may launch a web browser 330 and navigate to a particular uniform resource locator (URL). The user may then interact with various elements provided by the browser (e.g., menus, buttons, text inputs, etc.). Such interactions may be evaluated by the server-side application 320, which in turn provides updated code to the web browser. In this way, multiple users may interact with the server to participate in one or more events. Further operation of the server application 300 will be described in more detail in reference to Section II below.

One of ordinary skill in the art will recognize that the system 300 is conceptual in nature and may be implemented in various different ways without departing from the spirit of the invention. For instance, various elements may be removed and/or various other elements may be included. In addition, multiple elements may be combined into a single element and/or a single element may be divided into multiple elements. Furthermore, various other communication pathways may be utilized and/or included.

### II. Methods of Operation

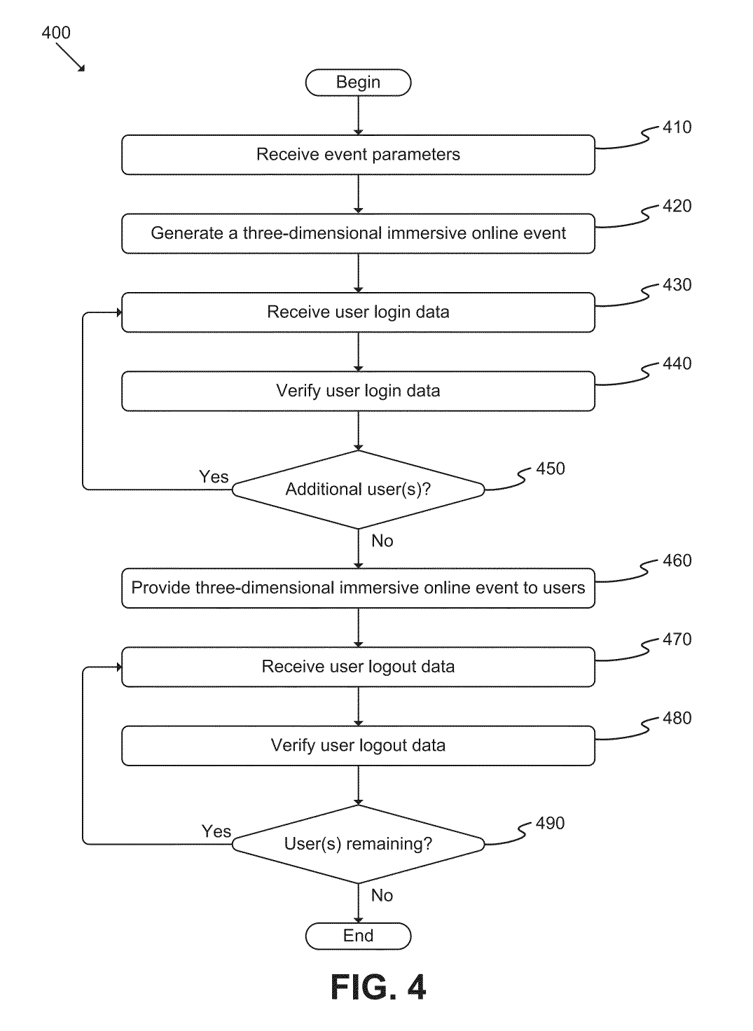

FIG. 4 illustrates a flow chart of a conceptual process 400 used by some embodiments of the invention to set up a three-dimensional online event. Process 400 may begin, for instance, when a user initiates set up of a 3D online event.

Process 400 may then receive (at 410) various event parameters. Such parameters may include the date and time of the event, the duration of the event, the event setting/venue, and/or other customizations (e.g., graphics, logos, banners, 3D furniture/accessories, etc.). The process may be at least partially implemented using a website where an event creator may create an account and define a set of event parameters. The creator of the event may notify potential attendees of the event by sending a link to the virtual event by email and/or any other appropriate way. The creator of the event may send a reminder of the event to invited attendees and/or confirmed event registrants. Next, the process may generate (at 420) a 3D immersive online event based on the event parameters.

The process may then receive (at 430) user login data. Such login data may include a user account name, account password, device identification, etc. Users may choose to enter the event using various social network identities and/or various user avatars. Process 400 may then verify (at 440) user login data. Such verification may include comparing the data to stored user data and sending a confirmation signal, message, and/or other appropriate indicator that the login data has been verified (or denying the login when the information does not match).

Next, the process may determine (at 450) whether there are additional users attempting to log in. If the process determines there are additional users, the process may perform operations 430-450 multiple times. If the process determines (at 450) there are no additional users, the process may provide (at 460) a 3D immersive online event to the users. During the event, various user interactions may take place and the user may receive various data elements and/or provide various data elements. If a user decides to leave the event, the process may then receive (at 470) user logout data. Next, the process may verify (at 480) the user logout data and logout the user.

Process 400 may then determine (at 490) whether there are additional users remaining in the event. If the process determines that there are remaining users, the process may perform operations 470-490 multiple times. If the process determines (at 490) that there are no users remaining in the event, the process may end. Alternatively, the process may end at a predetermined time, when an organizer provides an indication, and/or at other appropriate times.

After the event, the event creator may be able to retrieve information regarding the attendees (e.g., who attended, how long they stayed in the virtual space, what they did while attending, etc.).

One of ordinary skill in the art will recognize that process 400 is conceptual in nature and may be implemented in various different ways without departing from the spirit of the invention. For instance, the operations may be performed in different orders. As another example, various operations may be omitted and/or other operations may be included. Furthermore, the process, or portions thereof, may be executed as part of a larger macro-process, and/or divided into multiple sub-processes. Moreover, the process, or portions thereof, may be executed continuously, at regular intervals, based on certain criteria, and/or in other appropriate ways.

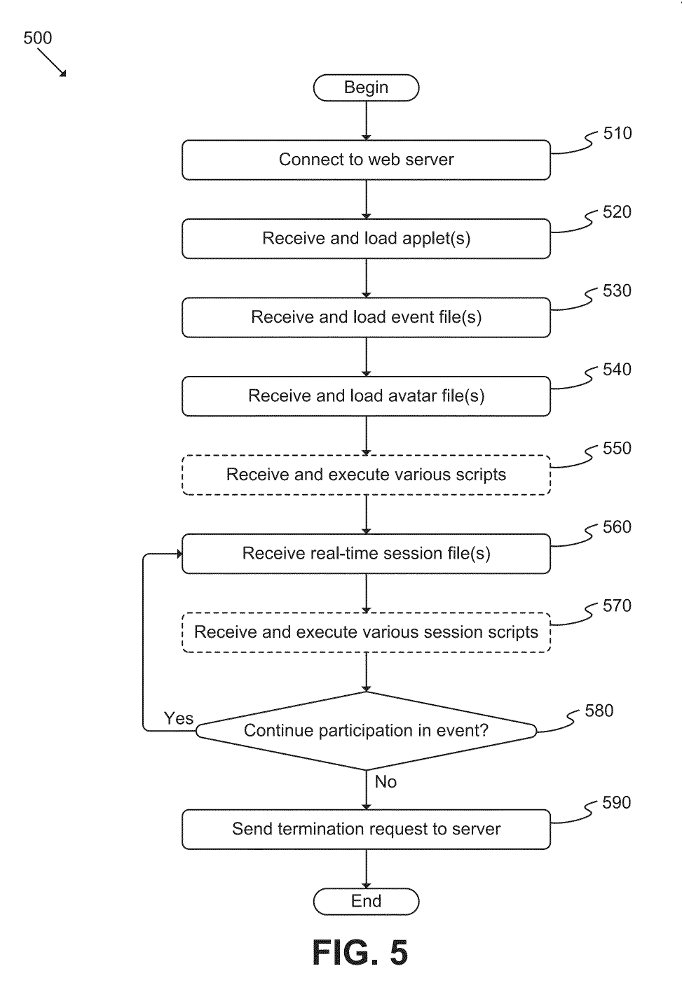

FIG. 5 illustrates a flow chart of a conceptual process 500 used by some embodiments of the invention to allow a user to participate in an event of some embodiments. Such a process may be implemented by a user device of system 100 and/or architecture 300, for example. Process 500 may begin, for instance, when a user launches a browser.

Process 500 may then connect (at 510) to a web server. Such a connection may be made in various appropriate ways (e.g., navigation to a particular URL). The process may connect to various other servers as appropriate (e.g., a data server, a relay server, etc.). The process then may receive and load (at 520) one or more applets, if necessary. Such applets may include various elements intended to run on existing cross-platform computing environments. Process 500 may then receive and load (at 530) one or more event files. Such event files may include various parameters associated with an event (e.g., size, shape, and/or attributes of an event space, information regarding the event itself (e.g., information regarding a lecturer participating in the event, potential topics of presentation, etc.), etc.).

The process may then receive and load (at 540) one or more avatar files. Such files may include various attributes of user avatars. Each avatar file may be associated with a particular avatar that is associated with a particular user. In some embodiments, a user must log in and be validated before receiving any avatar files. For instance, a user may have a username and password associated with an existing account that is associated with one or more avatar files. The user may enter the username and password on a user device, which may then send the information to the server for authentication. If the server authenticates the user, the avatar files may be provided (and/or other functionality and/or data may be provided). If the server is unable to authenticate the user, the user may be denied access to user-specific files and the process may end.

The process may then receive and execute (at 550) various scripts. The scripts may be executed by a user device and may provide various features of some embodiments. One of ordinary skill in the art will recognize that such scripts may be received and loaded at various times throughout the process. In addition, different scripts may be received and/or loaded at different times.

Next, the process may receive (at 560) one or more real-time session files. Such files may each include information regarding an event (e.g., parameters regarding the event space, information regarding locations of avatars associated with other participants, etc.). The process may then receive and execute (at 570) various session scripts. Such real-time session scripts may allow the user to interact with the event in various ways (e.g., by moving an avatar associated with the user to a different location within the event space).

Process 500 may then determine (at 580) whether the user wishes to continue participation in the event. Such a determination may be made in various appropriate ways (e.g., the process may determine whether the user has performed any actions over a specific time period, the process may determine whether the user has selected an option to leave the event, etc.). If the process determines (at 580) that the user wishes to continue participation in the event, the process may repeat operations 560-580. Otherwise, if the process determines (at 580) that the user does not want to continue participation in the event, the process may send (at 590) a termination request to the server. Such a request may involve sending a message, flag, and/or other appropriate element that may be recognized by the server.

Although process 500 has been described with reference to a single user, one of ordinary skill in the art will recognize that multiple iterations of the process may be performed in parallel, thus allowing multiple users to participate in an event at the same time.

One of ordinary skill in the art will recognize that process 500 is conceptual in nature and may be implemented in various different ways without departing from the spirit of the invention. For instance, the operations may be performed in different orders. As another example, various operations may be omitted and/or other operations may be included. Furthermore, the process, or portions thereof, may be executed as part of a larger macro-process, and/or divided into multiple sub-processes. Moreover, the process, or portions thereof, may be executed continuously, at regular intervals, based on certain criteria, and/or in other appropriate ways.

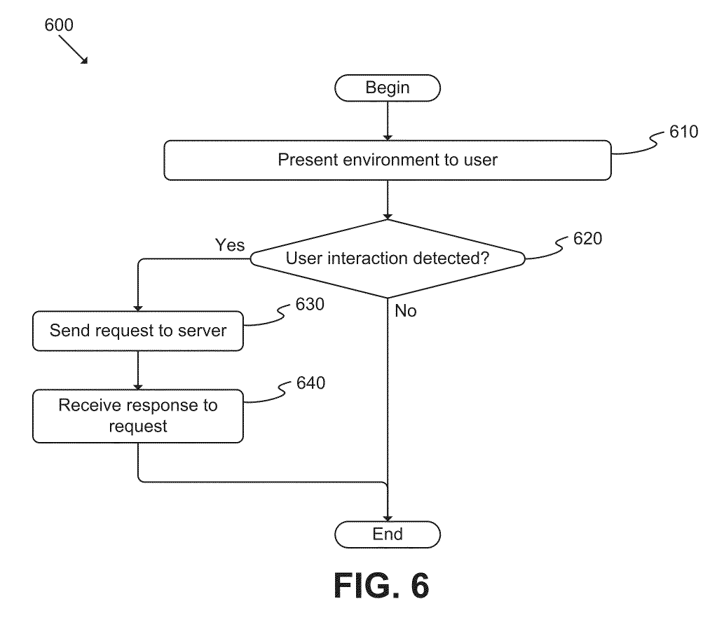

FIG. 6 illustrates a flow chart of a conceptual process 600 used by some embodiments of the invention to allow user interaction during a 3D online event. Process 600 may be performed while a user participates in an online event. For instance, the operations of the process may be performed alternatively to and/or conjunctively with operations 560-580 described above in reference to process 500.

Process 600 may present (at 610) an environment to a user. Such an environment may include 3D multimedia and may allow the user to perceive a virtual space and/or various avatars within the space, where each avatar may be associated with a user.

Next, the process may determine (at 620) whether any user interaction is detected. Such interaction may include such elements as combinations of keystrokes, selecting and/or moving objects with a cursor control feature (e.g., a mouse, a touchscreen, etc.). Such interactions may allow a user to control various aspects of the participation of the avatar (and thus the user) within the virtual space (e.g., a user may be able to move the avatar to a desired location within the virtual space, may be able to direct the view of the avatar in a particular direction, etc.).

If the process detects (at 620) a user interaction, the process may send (at 630) a request to the server. Such a request may include various parameters, data, commands, etc. that may be associated with actions a user (and an associated avatar) may perform during an event. Such performance may include moving an avatar, interacting with other user avatars, etc. Next, the process may receive (at 640) a response to the request. Such a response may involve sending a message, flag, and/or other appropriate element that may be recognized by the user device (and/or a client application running on that device).

After receiving (at 640) the response, or after determining (at 620) that no user interaction has been detected, the process may end.

One of ordinary skill in the art will recognize that process 600 is conceptual in nature and may be implemented in various different ways without departing from the spirit of the invention. For instance, the operations may be performed in different orders. As another example, various operations may be omitted and/or other operations may be included. Furthermore, the process, or portions thereof, may be executed as part of a larger macro-process, and/or divided into multiple sub-processes. Moreover, the process, or portions thereof, may be executed continuously, at regular intervals, based on certain criteria, and/or in other appropriate ways.

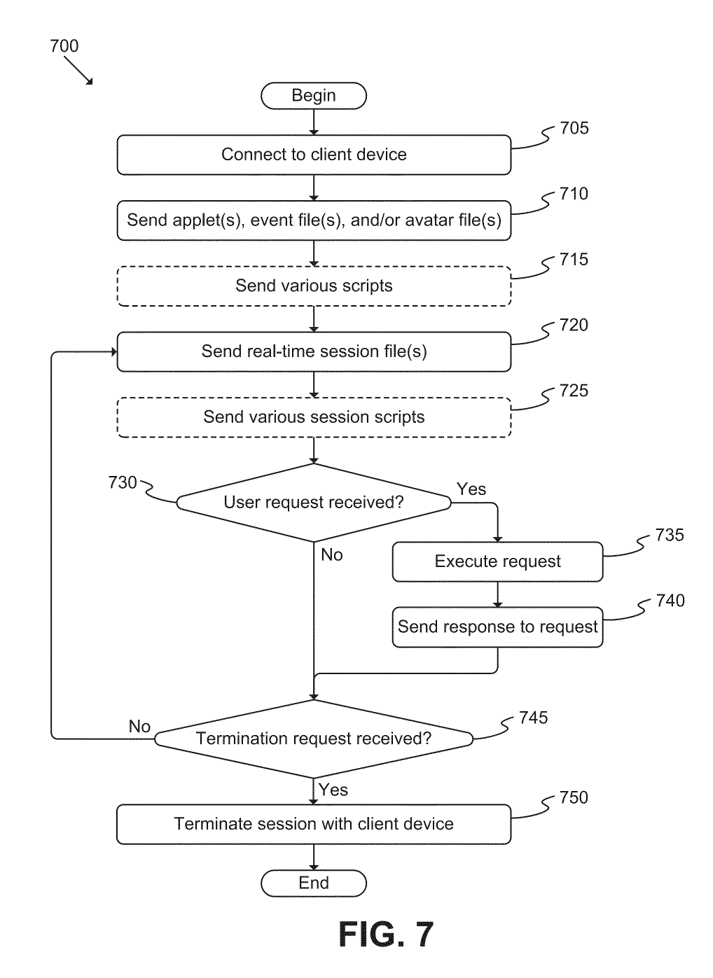

FIG. 7 illustrates a flow chart of a conceptual process 700 used by some embodiments of the invention to provide a server-side application for a user participating in an event. The process may begin, for instance, when a URL associated with the system is made available to one or more users.

Process 700 may then connect (at 705) to a client device associated with the user. Such a connection may be made in various appropriate ways (e.g., the client device may navigate to a particular URL). The process may connect to various other devices as appropriate. The process then may send (at 710) one or more applets, event files, and/or avatar files to the client device. Such applets may include various elements intended to run on existing cross-platform computing environments. Such event files may include various parameters and information associated with an event. Such avatar files may include various attributes of user avatars. Each avatar file may be associated with a particular avatar that is associated with a particular user. In some embodiments, a user must log in and be validated before receiving any avatar files. For instance, a user may have a username and password associated with an existing account that is associated with one or more avatar files. The user may enter the username and password on a user device, which may then send the information to the server for authentication. If the server authenticates the user, the avatar files may be provided (and/or other functionality and/or data may be provided). If the server is unable to authenticate the user, the user may be denied access to user-specific files and the process may end.

The process may then send (at 715) various scripts. The scripts may be executed by a user device and may provide various features of some embodiments. One of ordinary skill in the art will recognize that such scripts may be sent at various times throughout the process. In addition, different scripts may be sent at different times.

Next, the process may send (at 720) one or more real-time session files. Each session file may include information regarding a current session of the user. Such information may include various parameters and data associated with the event space, the user avatar, event media (e.g., a user may view an interactive presentation in real-time), etc. The process may then send (at 725) various session scripts. Such real-time session scripts may allow the user to interact with the event space and/or other event participants in various ways.

Process 700 may then determine (at 730) whether a user request has been received. If the process determines (at 730) that a user request has been received, the process may execute (at 735) the request and send (at 740) a response to the client device. The execution of the request may include performing various operations, sending messages to other users, storing data, and/or other appropriate actions that may be undertaken by the server. Such a response may include various parameters, data, commands, etc. that may indicate to a user of the client device the results of the request.

Process 700 may then determine (at 745) whether a termination request has been received. Such a determination may be made in various appropriate ways (e.g., a user may direct an associated avatar to “leave” the event space, a user may select a logout option, the server may determine that a client device is no longer connected, etc.). If the process determines (at 745) that no termination request has been received, the process may repeat operations 720-745. Otherwise, if the process determines (at 745) that a termination request has been received, the process may terminate (at 750) the session with the client device. Such a termination may involve sending a message, flag, and/or other appropriate element that may be recognized by the client device. Alternatively, after a termination, the server may simply stop communicating with the client device.

Although process 700 has been described with reference to a single user, one of ordinary skill in the art will recognize that multiple iterations of the process may be performed in parallel, thus allowing multiple users to participate in an event at the same time.

One of ordinary skill in the art will recognize that process 700 is conceptual in nature and may be implemented in various different ways without departing from the spirit of the invention. For instance, the operations may be performed in different orders. As another example, various operations may be omitted and/or other operations may be included. Furthermore, the process, or portions thereof, may be executed as part of a larger macro-process, and/or divided into multiple sub-processes. Moreover, the process, or portions thereof, may be executed continuously, at regular intervals, based on certain criteria, and/or in other appropriate ways.

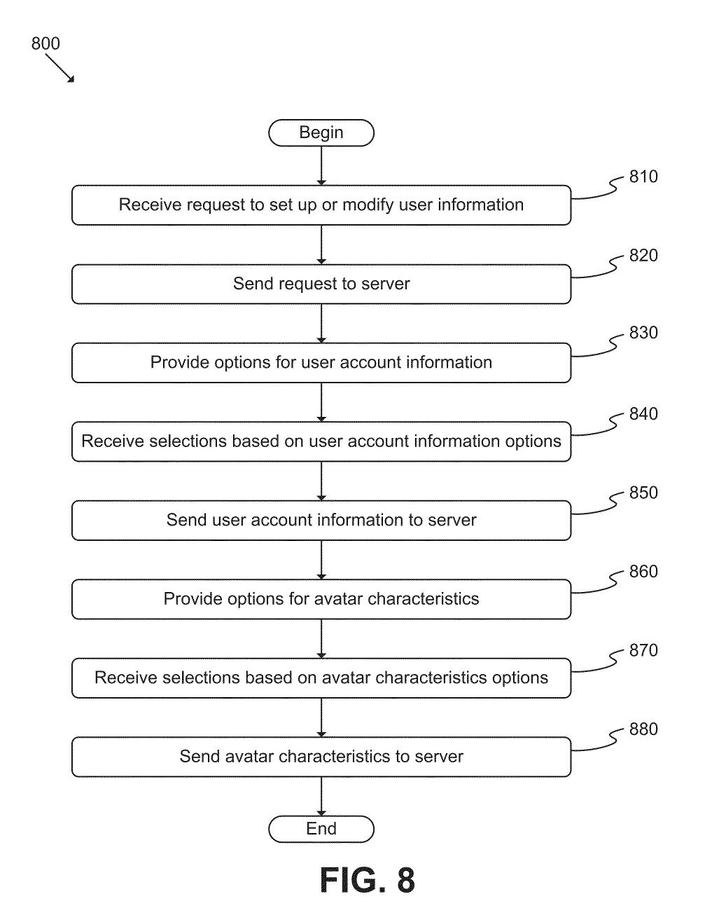

FIG. 8 illustrates a flow chart of a conceptual process 800 used by some embodiments of the invention to create an avatar and/or user account. The process may begin, for instance, when a user navigates to a particular URL and selects an option to create an avatar and/or user account.

Process 800 may then receive (at 810) a request to set up or modify user account information. Such a request may be received by a user device, where a user may select an option (e.g., by clicking a link, button, etc.) to create a new account (and/or avatar) or modify an existing account (and/or avatar). The process may then send (at 820) a request to the server of some embodiments. Such a request may include various elements (e.g., a message, flag, etc. that may be interpreted by the server).

Next, the process may provide (at 830) options related to user account information (e.g., name, address, company, age, etc.). Such options may be presented using various appropriate user interface (UI) elements. The process may then receive (at 840) a set of selections based on the provided options. Such selections may include selecting items from a list (e.g., a drop-down or pop-up list, a set of radio buttons, etc.), entering information into text fields (e.g., selecting a text box and typing some information into the box), and/or other appropriate ways of receiving user selections. The process then may send (at 850) the received selections, indicating user account information, to the server of some embodiments.

Next, the process may provide (at 860) options related to avatar characteristics (e.g., height, weight, hair color, clothing, gender, etc.). Such options may be presented using various appropriate user interface (UI) elements. The process may then receive (at 870) a set of selections based on the provided options. The process then may send (at 880) the received selections, indicating avatar information, to the server of some embodiments.

Although the process 800 of FIG. 8 has been described from the perspective of a client-side application, one of ordinary skill in the art will recognize that process 800 may have a server-side counterpart in some embodiments. Such a server-side application may receive data and/or instructions from the client-side application and/or send data and/or instructions to the client-side application in some embodiments and may perform essentially corresponding operations to the operations of process 800.

One of ordinary skill in the art will recognize that process 800 is conceptual in nature and may be implemented in various different ways without departing from the spirit of the invention. For instance, the operations may be performed in different orders. As another example, various operations may be omitted and/or other operations may be included. Furthermore, the process, or portions thereof, may be executed as part of a larger macro-process, and/or divided into multiple sub-processes. Moreover, the process, or portions thereof, may be executed continuously, at regular intervals, based on certain criteria, and/or in other appropriate ways.

### III. Graphical User Interface Features

The following section will describe various graphical user interface (GUI) features of specific example implementations that may use elements of the system, architecture, software, and/or methods described above. Such features are presented for example purposes only. One of ordinary skill in the art will recognize that different embodiments may implement various specific elements in various different ways.

Some embodiments of the invention may allow an event organizer to set up an event using an instant self-service process. Such an event may be setup and/or made available to participants with no delay. Such delays may typically result from, for instance, non-automated actions needed to define and/or create the 3D environment, apply custom logos, graphics and/or other custom visuals to a template chosen form a library of ready-made templates of conference rooms or exhibitions halls, and/or perform other setup operations (i.e., various support personnel may be needed and an organizer may not be able to set up an event directly). In the following example, the process may include three steps, but one of ordinary skill in the art will recognize that different specific numbers of steps or operations may be used in different embodiments.

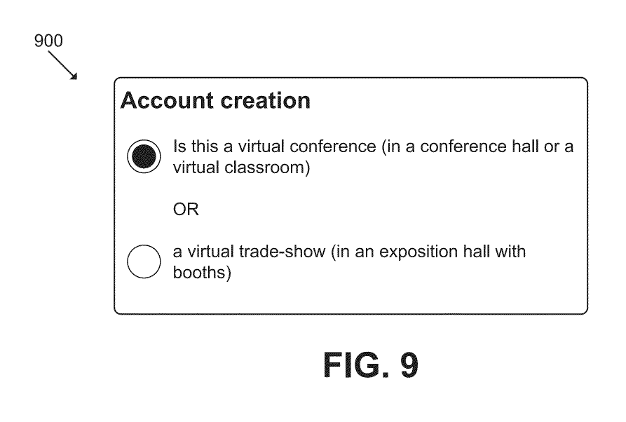

The self-service event setup may provide various automated features (e.g., sets of selections, data entry elements, etc.) that allow an event organizer to setup a virtual event venue. FIGS. 9-11 below illustrate an example set of GUIs that may provide such an automated setup by allowing an event planner or organizer to instantly setup an event and customize the virtual 3D venue in a self-service way, without having any specific 3D design skills.

FIG. 9 illustrates an example GUI 900 provided by some embodiments of the invention. Specifically, this figure shows an example of a GUI that may be used during creation of a user account. As shown, this example GUI may include an option to create a virtual conference or a virtual trade-show. Different embodiments may present different options in various different ways (e.g., drop-down menus, selectable lists, radio buttons, etc.). Different embodiments may provide different sets of options, where each set may include different numbers of sub-options or components.

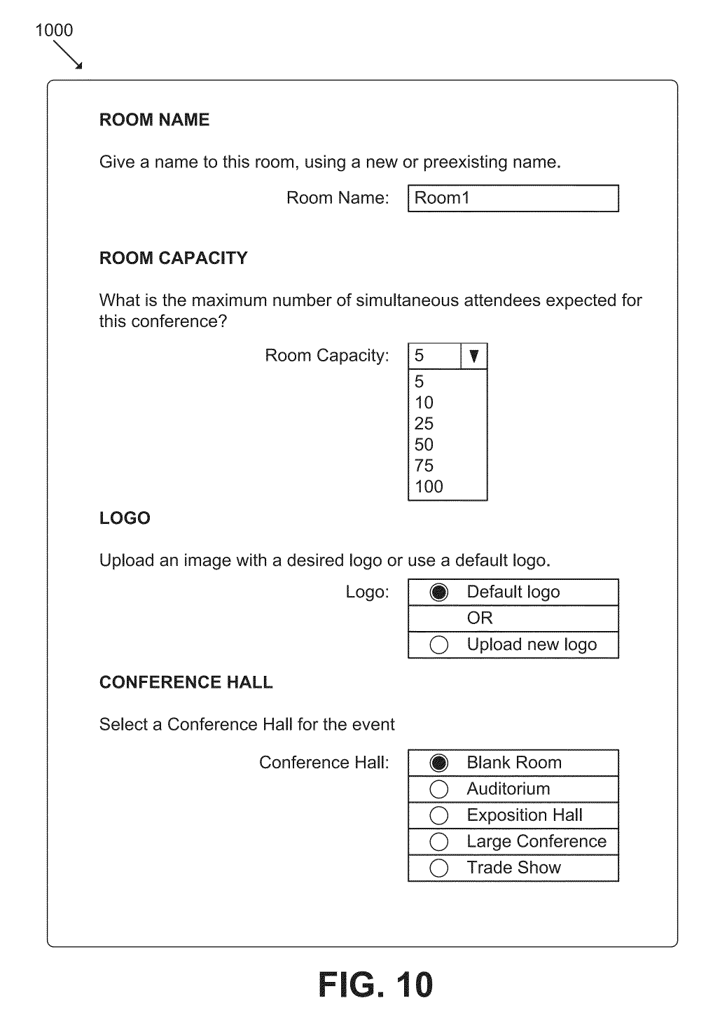

FIG. 10 illustrates another example GUI 1000 used by some embodiments of the invention. Specifically, this figure shows an example of a GUI that may be used to select various event parameters. Such a GUI 1000 may be presented subsequent to the user making a selection from GUI 900. As shown, GUI 1000 may include event parameters such as room name, room capacity, logo, and type of conference hall. Different embodiments may present different sets of options in various different ways.

In this example, a user setting up an online event may begin by choosing a room name. The room name may be a preexisting name or the user may enter a new room name. The user may then select the room capacity (i.e., the maximum number of simultaneous attendees expected for the event) from a drop-down menu.

The user may then select a logo to be used at the event. Such a logo may be a default logo, or the user may upload an image with a new desired logo. Finally, the user may select a type of conference hall for the event. In this example, different types of conference hall types may include a blank room, auditorium, exposition hall, large conference, or trade show.

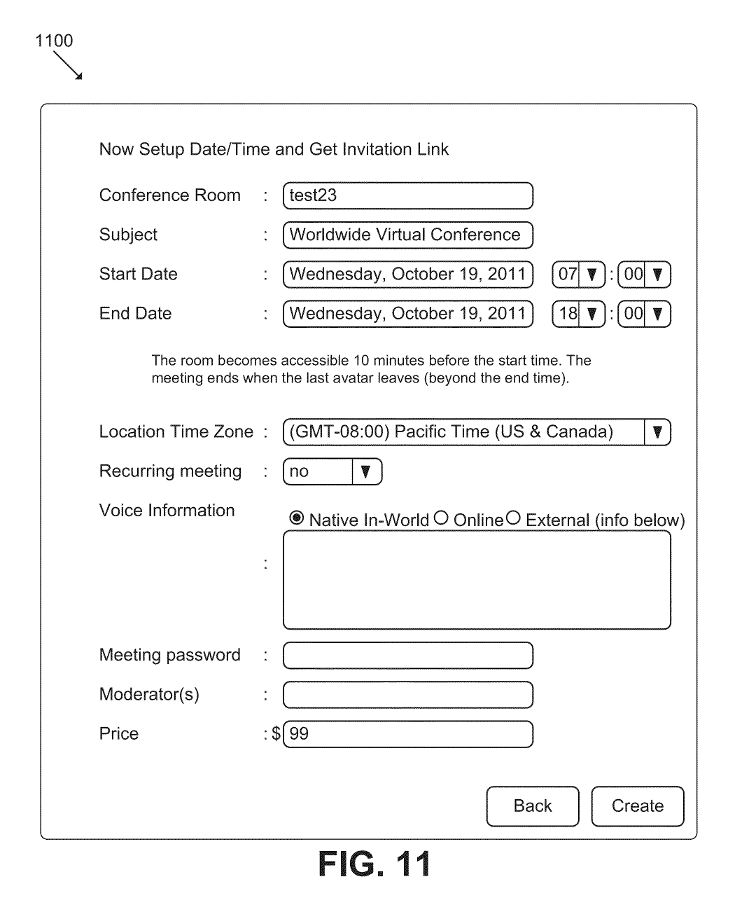

FIG. 11 illustrates yet another example GUI 1100 used by some embodiments of the invention. Specifically, this figure shows an example of a GUI that may be used to set up the date and time for an event, and to receive an invitation link. Such a GUI 1100 may be presented subsequent to the user making a selection from GUI 1000.

As shown, GUI 1100 may include event parameters such as conference room type, conference subject, start date/time, end date/time, local time zone, whether or not the conference is recurring, voice information, a meeting password, meeting moderators (if any), and the price of attending the event. Different embodiments may include different parameters and/or different options.

In some embodiments, the GUIs 900-1100 (and/or other GUIs) may be provided in succession such that an event organizer, who has no 3D design skills, is able to instantly setup an event without delay in a completely self-service way.

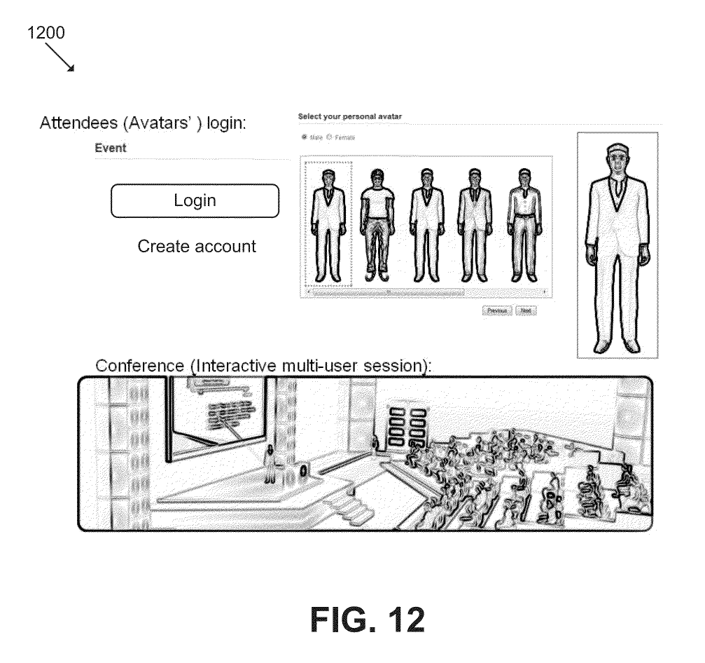

FIG. 12 illustrates another example GUI 1200 provided by some embodiments of the invention. Specifically, this figure shows an example of a GUI that may be used to allow attendees to log in to an event, select a personal avatar, and participate in an interactive multi-user conference. Such a GUI may be presented, for example, when a user attempts to participate in an event. Alternatively, such a GUI may be presented to an event organizer after the organizer has proceeded through GUIs 900-1100.

Each attendee may log in to the event via various social networking and/or other external accounts, and/or any other appropriate way. Each attendee may select a personal avatar to use during the event. Each attendee may select the gender of their avatar and then may choose from a number of different avatar-types to use during the event. Alternatively, each user may create a unique avatar (e.g., before the event) and save the avatar data so that the user may use the personalized avatar at various different events. Furthermore, each user may create various different avatars, and may select a particular avatar for a particular event based on the event-type, personal preference, etc. The process for creating a user avatar is described in more detail in reference to FIG. 8 above.

As shown in FIG. 12, a user may also be able to view the event such that the user is able to interact with the environment and/or other users participating in the event. Such interaction may be facilitated by allowing the user to move the avatar within the environment and operate various facilities (e.g., a lecturer may be able to use an avatar to operator a multimedia display during a presentation) and/or interact with other users (e.g., a participant may be able to communicate with other participants using their avatars). In some embodiments, a user may be able to manipulate the avatar in order to access various sub-locations within an event (e.g., at a trade-show type event, a user may navigate from one virtual booth to another by moving the avatar within the virtual environment).

One of ordinary skill in the art will recognize that the GUIs 900-1200 are conceptual in nature and may be implemented in various different ways without departing from the spirit of the invention. For instance, the GUI options may be arranged in different orders and/or with different interfaces. As another example, certain information in the GUIs may be omitted and/or other information may be included. Furthermore, in other embodiments, various other GUIs may be used in other appropriate ways.

### IV. Process for Defining a Three-dimensional Online Event Application

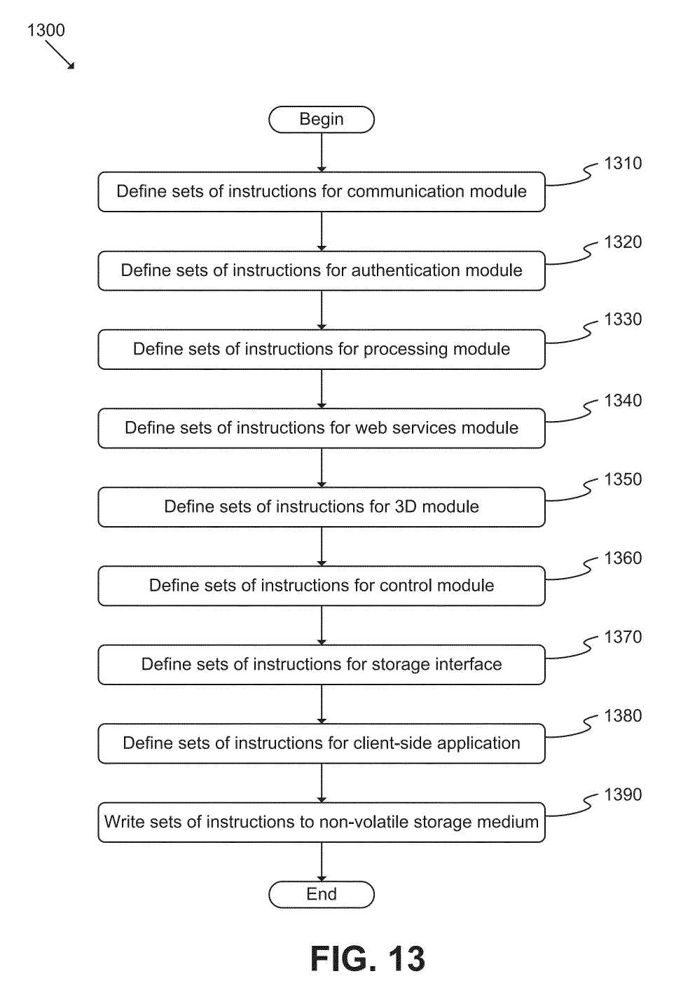

FIG. 13 conceptually illustrates a process 1300 of some embodiments for defining and storing a set of 3D event applications of some embodiments, such as the application provided by system 300 described above in reference to FIG. 3. Specifically, process 1300 illustrates the operations used to define sets of instructions for providing several of the elements shown in the 3D event application system 300 and for performing various operations described above.

As shown, the process may define (at 1310) sets of instructions for providing a communication module. The process may then define (at 1320) sets of instructions for providing an authentication module. Next, the process may define (at 1330) sets of instructions for providing a processing module. Process 1300 may then define (at 1340) sets of instructions for providing a web services module. The process may then define (at 1350) sets of instructions for providing a 3D module. Next, the process may define (at 1360) sets of instructions for providing a control module. Process 1300 may then define (at 1370) sets of instructions for providing a storage interface. The process may then define (at 1380) sets of instructions for providing a client-side application. Such a client-side application may be provided to a client device at run-time (i.e., a server may include sets of instructions for a client-side application in the form of a script and/or other appropriate form, and may provide the instructions to a client device at run-time such that the client device may implement the client-side application). The process may then write (at 1390) the sets of instructions defined at operations 1310-1380 to a non-volatile storage medium.

One of ordinary skill in the art will recognize that the various sets of instructions defined by process 1300 are not exhaustive of the sets of instructions that could be defined and established on a non-volatile storage medium for 3D event applications incorporating some embodiments of the invention. In addition, process 1300 is a conceptual process, and the actual implementations may vary. For example, different embodiments may define the various sets of instructions in a different order, may define several sets of instructions in one operation, may decompose the definition of a single set of instructions into multiple operations, etc. In addition, process 1300 may be implemented as several sub-processes or combined with other operations within a macro-process.

### V. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

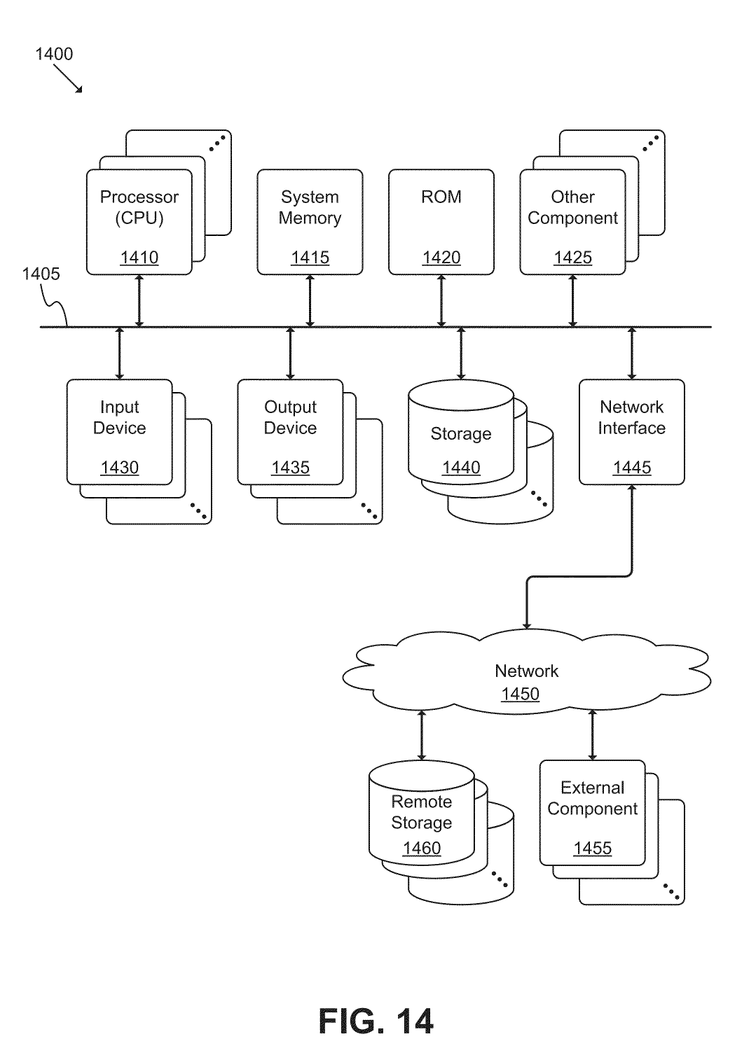

FIG. 14 conceptually illustrates a schematic block diagram of a computer system 1400 with which some embodiments of the invention may be implemented. For example, the systems described above in reference to FIGS. 1-3 may be at least partially implemented using computer system 1400. As another example, the processes described in reference to FIGS. 4-8 may be at least partially implemented using sets of instructions that are executed using computer system 1400.

Computer system 1400 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 1400 may include a bus 1405, at least one processing element 1420, a system memory 1430, a read-only memory (“ROM”) 1440, other components (e.g., a graphics processing unit) 1450, input devices 1460, output devices 1470, permanent storage devices 1480, and/or a network connection 1490. The components of computer system 1400 may be electronic devices that automatically perform operations based on digital and/or analog input signals. For instance, the various examples of client and server applications described above in reference to FIGS. 9-12 may be at least partially implemented using sets of instructions that are run on computer system 1400.

Bus 1405 represents all communication pathways among the elements of computer system 1400. Such pathways may include wired, wireless, optical, and/or other appropriate communication pathways. For example, input devices 1430 and/or output devices 1435 may be coupled to the system 1400 using a wireless connection protocol or system. The processor 1410 may, in order to execute the processes of some embodiments, retrieve instructions to execute and data to process from components such as system memory 1415, ROM 1420, and permanent storage device 1440. Such instructions and data may be passed over bus 1405.

ROM 1420 may store static data and instructions that may be used by processor 1410 and/or other elements of the computer system. Permanent storage device 1440 may be a read-and-write memory device. This device may be a non-volatile memory unit that stores instructions and data even when computer system 1400 is off or unpowered. Permanent storage device 1440 may include a mass-storage device (such as a magnetic or optical disk and its corresponding disk drive).

Computer system 1400 may use a removable storage device and/or a remote storage device as the permanent storage device. System memory 1415 may be a volatile read-and-write memory, such as a random access memory (“RAM”). The system memory may store some of the instructions and data that the processor uses at runtime. The sets of instructions and/or data used to implement some embodiments may be stored in the system memory 1415, the permanent storage device 1440, and/or the read-only memory 1420. For example, the various memory units may include instructions for creating 3D online events in accordance with some embodiments.

Other components 1425 may perform various other functions. These functions may include, for example, 3D rendering functions.

Input devices 1430 may enable a user to communicate information to the computer system and/or manipulate various operations of the system. The input devices may include keyboards, cursor control devices, audio input devices and/or video input devices. Output devices 1435 may include printers, displays, and/or audio devices. Some or all of the input and/or output devices may be wirelessly or optically connected to the computer system.

Finally, as shown in FIG. 14, computer system 1400 may be coupled to a network 1450 through a network adapter 1445. For example, computer system 1400 may be coupled to a web server on the Internet such that a web browser executing on computer system 1400 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1400 may be used in conjunction with the invention. Moreover, one of ordinary skill in the art will appreciate that many other system configurations may be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

In addition, while many examples above may describe “moving” an avatar, “entering” an event space, and/or other similar descriptions, one of ordinary skill in the art will recognize that such actions are virtual actions, and represent changing representations (e.g., visual displays) that may be provided to one or more users of the system of some embodiments.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

We claim:

1. A system adapted to provide a plurality of immersive three-dimensional (3D) event spaces to a plurality of sets of users, each set of users associated with a particular 3D event space, the system comprising:
a set of web servers adapted to provide a plurality of uniform resource locators (URLs), each URL associated with a particular 3D event space;
a set of storages communicatively coupled to the set of web servers; and
a plurality of sets of user devices communicatively coupled to the set of web servers across one or more networks, each set of user devices associated with a particular 3D event space.

2. The system of claim 1, wherein the set of web servers is able to provide, for each particular event space, a set of applets, a set of scripts, and a set of avatar files.

3. The system of claim 1, wherein each 3D event space includes at least one 3D-rendered element that is able to be displayed on a user device from the sets of user devices.

4. The system of claim 3, wherein each 3D-rendered element includes a representation of an avatar associated with a particular user, the particular user associated with a particular user device.

5. The system of claim 1, wherein each user device is adapted to be able to access a URL from the plurality of URLs using a web browser.

6. The system of claim 5, wherein the web browser is adapted to interpret hypertext markup language, version 5 (HTML5) code.

7. The system of claim 6, wherein the web browser is adapted to access a particular 3D event space without requiring download of any applets.

8. The system of claim 1, wherein each user in a particular set of users is able to interact with each other user in the particular set of users in the particular 3D event space

9. An automated method adapted to set up and host a virtual event, the method comprising:
receiving a set of event parameters from an event planner;
generating a three-dimensional (3D) immersive event space based at least partly on the set of event parameters; and
providing the 3D event space to a plurality of participants, wherein each participant is able to access a uniform resource locator (URL) associated with the event space using a web browser.

10. The automated method of claim 9, wherein each participant is associated with a customizable avatar.

11. The automated method of claim 10, wherein each customizable avatar is able to be manipulated by the associated participant during the virtual event.

12. The automated method of claim 10, wherein the set of event parameters comprises a set of parameters defining dimensions of the event space.

13. The automated method of claim 12, wherein the set of event parameters comprises a sub-set of parameters defining facilities provided by the event space.

14. The automated method of claim 13, wherein the facilities include at least one multimedia display element.

15. The automated method of claim 13, wherein the facilities include a set of available avatar locations.

16. The automated method of claim 9, wherein the 3D immersive event space is provided instantly and is generated using a self-service process that does not require 3D design skills.

17. A graphical user interface (GUI) comprising a set of features that allow self-service, instant setup of a three-dimensional (3D) immersive event space, the GUI comprising:
a set of selectable elements, each selectable element associated with a type of event;
a first set of data entry fields, each data entry field in the first set of data entry fields being associated with one or more parameters that define features of the 3D immersive event space; and
a second set of data entry fields, each data entry field in the second set of data entry fields being associated with one or more parameters that define features of an event associated with the 3D immersive event space, wherein the defined features include visible graphics related to a virtual venue included in the 3D immersive event space.

18. The GUI of claim 17, wherein the first set of data entry fields includes at least one text entry field, at least one drop-down menu, and at least one set of radio buttons.

19. The GUI of claim 17, wherein the second set of data entry fields includes at least one text entry field, at least one data entry field associated with a date, and at least one data entry field associated with a time.

20. The GUI of claim 17, wherein the GUI is provided in a web browser.
